(19) United States
(12) Patent Application Publication
(10) Pub. No.: US 2012/0306471 A1
(43) Pub. Date: Dec. 6, 2012

(54) METHOD AND APPARATUS FOR PERFORMING ON-LOAD MECHANICAL SWITCHING OPERATIONS

(76) Inventors: Timothy Charles Green, Haywards Heath (GB); Daniel James Rogers, Bristol (GB)

(21) Appl. No.: 13/395,848

(22) PCT Filed: Sep. 14, 2010
(86) PCT No.: PCT/GB10/01731

§ 371 Date: Aug. 20, 2012

(30) Foreign Application Priority Data
Sep. 15, 2009 (GB) 0916190.2

(51) Int. Cl. H02J 3/00

(52) U.S. Cl. 323/355

(57) ABSTRACT

An electrical device comprising: a first current path having a primary switch therein, and means for coupling to an electrical supply; and a diversionary current path having semiconductor switching means therein, the semiconductor switching means being operable to bypass the primary switch; the device being arranged such that, in use, a first current flowing from the supply along the first current path can be diverted, on the operation of the semiconductor switching means, along the diversionary current path, bypassing the primary switch; wherein the diversionary current path comprises a controllable electrical supply operable to supply a second current whilst the semiconductor switching means are in a state of conduction, the second current being such as to cause substantially zero current to flow through the primary switch, such that the primary switch can then be opened under a condition of substantially zero load current. A corresponding method of operating a mechanical switch in such a device is also provided. The disclosure further provides a controllable electrical supply comprising: an electrical source; an amplifier having two output terminals and comprising a plurality of semiconductor devices; and control logic arranged to operate the amplifier such that it can selectively present both current and voltage source behaviour at the terminals.

This invention is in the field of electrical and electromechanical devices, and relates to apparatus and a corresponding method for performing on-load mechanical switching operations (i.e. operating a mechanical switch whilst the switch contacts are under electrical load). The invention is particularly suitable, but by no means limited, for performing on-load tap changes in electrical transformers.

### BACKGROUND TO THE INVENTION

Mechanical switching devices that are switched whilst under electrical load are susceptible to arcing at the electrical contacts of the switch. Such arcing can cause considerable wear to the electrical contacts, thereby shortening the useful lifetime of the device.

An example of such a switching device is an electrical transformer used in an electricity distribution system to change the magnitude of an AC voltage to suit a particular load. The ratio between input and output voltages is governed by the ‘turns ratio’ or ‘transformation ratio’ of the transformer. Distribution level on-load tap changing transformers are used to maintain customer supply voltage within statutory limits (despite variations elsewhere in the system) by varying the transformation ratio within the transformer. The on-load tap changer (hereafter ‘OLTC’) enables line voltage adjustments to be made without interrupting the load and so helps to maintain a reliable, well regulated supply to the customer.

Purely mechanical (or ‘classic’) OLTC systems are both slow and have a limited lifetime due to arc damage that occurs at the internal electrical contacts. As electrical networks evolve, there is a need for faster OLTC schemes that are able to perform a far greater number of life-time operations when compared to classic OLTCs.

Classic on-Load Tap Changers

With reference to FIG. 1, a classic OLTC is a simple electromechanical system consisting of a tap selector section 10, a diverter section 12 and some associated sensing and control systems. FIG. 1 illustrates a schematic representation of one phase of a classic OLTC.

An OLTC by definition operates under load, and therefore upon a tap change operation the load current flowing in one transformer tap must be broken and re-established in another tap by the OLTC, but in such a way that the load current is not interrupted. The requirement for a continuous load current means that it is necessary to incorporate a specialised system for managing tap transitions. This system is commonly termed the ‘diverter’.

Each phase of a classic OLTC diverter incorporates a spring loaded mechanical arm that is ‘fired’ when a tap change is desired. When fired, the diverter arm 13 moves rapidly across a set of four electrical contacts 14 in turn, allowing the load current to be commutated from one ‘leg’ of the diverter to the other. See FIG. 1 for a graphical representation of a diverter arm. The combination of diverter and selector allows tap n−1 or n+1 to be reached from the current tap n. Thus the classic OLTC allows any transformer tap to be selected by repeatedly operating the diverter and selector, incrementing or decrementing the tap selection by one each time. It is important to note that the tap selector is never required to make or break the load current and that this operation is handled by the diverter alone, therefore the tap selector contacts need only be rated to conduct the load current and are typically far more compact than the diverter contacts in the classic OLTC.

It should be noted that whilst a rated-240 MVA classic OLTC typically has between 15-25 taps giving a total 10% output voltage adjustment, it may take in the region of 4-8 seconds to complete a single tap-up or tap-down operation, and therefore is limited in its response to a rapidly varying network demand.

Semiconductor Assisted on-Load Tap Changers

It may be expected that the diverter component of a classic OLTC will inevitably suffer considerable contact wear due to electrical arcing; the diverter contacts must break and re-establish the entire load current as the diverter arm moves through its range of travel each time a tap change operation is requested. Indeed, the classic OLTC design requires relatively frequent maintenance when compared to its companion transformer, typically to check the state of the diverter contacts and also to establish the integrity of the insulating oil which can become contaminated by by-products of the arcing created by the diverter operation. Partly for this reason, as well as in an attempt to speed up operation and to reduce size, several alternative methods of tap changing and a variety of alternative OLTC designs have been proposed by researchers and industry over the past decade. Most (if not all) incorporate one or more semi-conductor devices (typically thyristors or gate turn-off (GTO) devices) in an attempt to reduce or eliminate arcing between a set of electrical contacts by providing alternative current paths at the instant of switching.

A semiconductor assisted OLTC may provide the operator with an opportunity to increase the number of tap change operations in a given maintenance interval over that which could be achieved with a classic OLTC. This give rise to two possibilities; either a lowering of long term running costs due to lower maintenance and downtime requirements for a given number of tap change operations, or an increase in operating flexibility due to an ability to make more frequent tap changes without incurring a corresponding shorter maintenance interval. The latter possibility could, for example, be used to maintain stricter line voltage tolerances with varying loads supplied by the OLTC: typically a classic OLTC may change taps twice in a 24 hour period to coincide with day time and night time demand variations, however a semiconductor assisted OLTC may allow hourly tap change operations which more closely reflect demand as it fluctuates throughout the day. The operator may therefore be able to tolerate greater load variations than otherwise possible or guarantee stricter voltage tolerances to their customers.

Unfortunately semiconductor assisted OLTC designs must contend with several issues, including an often substantially greater capital cost and concerns over the reliability of semiconductor devices in this application.

Problems with a Full-Semiconductor on-Load Tap Changer

A first step in the design of a new semiconductor OLTC might be to consider replacing the diverter with a fully solid state system. In this way, all arcing at the electrical contacts of the diverter would be eliminated and there would a corresponding reduction in problems associated with contact wear and dielectric contamination. The diverter contacts would simply be replaced by a set of thyristor valves and leg-to-leg commutation achieved by appropriate control of the gate drives. This scheme has two principle drawbacks both of which are connected with the fact that a semiconductor device would be continually conducting the load current. Firstly, a semiconductor device in the conduction path will incur a penalty in terms of large power loss over the case of the classic OLTC diverter as the forward voltage drop of a semiconductor junction is high compared to the resistive drop of a mechanical contact, leading to greater operating costs and a need for thermal management of the semiconductor devices. Secondly, semiconductor devices are typically far less tolerant to fault currents than mechanical switching devices, hence the semiconductor devices must either be over-rated in order to cope with possible fault conditions or further complex protection mechanisms must be considered.

### On-Load Tap Changer Designs in the Literature

The literature contains several OLTC diverter designs where the ‘steady state’ load current is carried by mechanical contacts and not by a semiconductor device, thus avoiding high conduction losses and minimising the time over which the semiconductor could be exposed to fault currents. In these schemes, a semiconductor based sub-circuit is used only to enable rapid and arc-less tap changing and is switched out of the circuit when a tap change has been completed. These designs can thus be regarded as hybrid designs because they utilise both mechanical contacts and semiconductor devices to achieve their function. This hybridisation allows the designer to exploit the strengths and avoid the weakness of both technologies; a mechanical contact is robust to over currents and is typically low loss, but suffers contact wear if required to interrupt current. On the other hand, a semiconductor device such as a thyristor is not appreciably degraded in the process of interrupting current but suffers comparably high conduction losses and a sensitivity to overload currents. The ‘hybrid’ OLTC designs presented in the literature can be broken down into two categories, those that use ‘passive diversion’ of load current and those that use ‘active diversion’.

### Passive Diverter Schemes

A good example of passive diversion is presented in [2]. In this scheme, a simple passive circuit uses the increasing voltage drop across an opening contact to trigger a thyristor into conduction, thus providing an alternate current path for the load current at the instant of contact separation. The design is entirely mechanically driven, hence the label of ‘passive’ operation; the sequence of events leading to current diversion is initiated by opening a set of mechanical contacts and does not require any complex electronic control mechanism. This is a valuable property for such a system that may be expected to operate reliably for long periods without intervention; however it is fundamentally limited in its ability to control arching at the mechanical contacts. By relying on the passive thyristor triggering method the circuit requires that a non-zero voltage must appear across the contacts in order for the thyristor to come into conduction, i.e. there will always be a period of time where the mechanical contact is conducting the load current and supporting the voltage necessary for triggering the thyristor. This state is likely to involve some degree of contact arcing. Another problem with this type of circuit is the issue of path inductance: FIG. 2 shows two parasitic inductances incorporated into the branches of a simplified diverter design, these inductances arise due simply to the physical design of the diverter circuits and therefore may be minimised but not entirely eliminated. In the steady-state condition, the load current I₃ flows entirely through the mechanical switch so that I₁=I₃ in order to minimise conduction losses (i.e. the diverter sub-circuit is not in operation). When a tap change is required, the switch begins to open, developing a voltage across it which triggers the diverter sub-circuit into conduction. In the ideal case the transfer of current between switch and diverter sub-circuit would occur instantaneously at this point. However, the parasitic inductances conspire to limit the rate of transfer of current from the ideal case. During the time period whilst the current in the switch is decreasing and the current in the diverter sub-circuit is increasing the switch is conducting current whilst its contacts are separated and hence is subject to arcing.

### Active Diverter Schemes

An active diverter scheme is defined by the inclusion of some form of active control of the internal semiconductor devices. In an active design the triggering of thyristors is no longer tied directly to the opening of a mechanical contact and instead takes place before any mechanical contacts are separated. This allows the system to establish an alternate current path before any mechanical switch is operated and force the diversion of current whilst the mechanical contact current path is still available. Therefore an active diverter scheme can achieve a transfer of load current out of the mechanical contact path before the contact is opened, technically eliminating contact arcing on opening. An example of active diversion is given in [1] and test results from an experimental set up are presented in [3].

Drawbacks of Various Passive and Active on-Load Tap-Changers

Unfortunately, there are drawbacks inherent in both the active and passive designs presented in the literature to date. All passive designs suffer from the inherent limitation that a mechanical switch is opened to trigger diversion of current and thus they must contend with the effect of parasitic inductances within the diverter circuit. This in turn means that at least some contact arcing must take place and so switch damage from arcing can never be entirely eliminated. A drawback with the method presented in [19], [3] and [4] is that an extra wound device (the ‘auxiliary current diverter’) is always in the load current path and is therefore a source of loss within the system. A further issue is that a semiconductor device, although not directly connected to the main system, is required to conduct at all times. Failure of this component will mean that the system cannot operate and must be taken out of service for repair.

### SUMMARY OF THE INVENTION

According to a first aspect of the present invention there is provided a method as defined in claim 1 of the appended claims. Thus there is provided an electrical device comprising: a first current path having a primary switch therein, and means for coupling to an electrical supply; and a diversionary current path having semiconductor switching means therein, the semiconductor switching means being operable to bypass the primary switch; the device being arranged such that, in use, a first current flowing from the supply along the first current path can be diverted, on the operation of the semiconductor switching means, along the diversionary current path, bypassing the primary switch; wherein the diversionary current path comprises a controllable electrical supply operable to supply a second current whilst the semiconductor switching means are in a state of conduction, the second current being such as to cause substantially zero current to flow through the primary switch, such that the primary switch can then be opened under a condition of substantially zero load current.

The terms “coupling” and “coupled” as used herein should be interpreted broadly, to encompass both direct electrical connection and also indirect connection, for example by inductive or capacitive means.

By virtue of the diversionary current path and the operation of the controllable electrical supply to provide a condition of substantially zero load current, the primary switch can be opened without arcing. As a consequence, contact wear of the switch may be reduced, and its lifetime may be increased, reducing the associated switch maintenance costs. Moreover, since the switch only needs to support the load current, rather than being able to tolerate contact wear associated with arcing, this enables the size of the switch to be decreased, and its moving mass to be reduced. This in turn may enable the speed of operation of the switch to be significantly increased (potentially so fast as to be able to operate in under half a cycle of an applied mains AC waveform). Additionally, since no semiconductor switching means are required in the first current path, undesirable power loss (as would be experienced through such devices) can be reduced. Furthermore, with no semiconductor devices in conduction during steady-state operation of the first current path, the electrical device is more resistant to faults, as no semiconductor device is required to handle possible fault currents during steady state operation.

Preferable, optional, features are defined in the dependent claims.

Thus, preferably the primary switch is a first primary switch and the semiconductor switching means is a first semiconductor switching means, and the electrical device further comprises a second current path having a second primary switch therein, the second current path being switchable into electrical connection with the said means for coupling to an electrical supply; and the diversionary current path has second semiconductor switching means therein connected to the second current path and operable to bypass the second primary switch; the device being arranged such that, in use, the first current flowing from the supply along the diversionary current path on the operation of the first semiconductor switching means therein can be further diverted, on the operation of the second semiconductor switching means, bypassing the second primary switch.

Preferably the controllable electrical supply is further operable to impose a voltage whilst the second semiconductor switching means are in a state of conduction, the voltage being such as to cause substantially zero voltage across the second primary switch when the second primary switch is open, such that the second primary switch can then be closed under a condition of substantially zero voltage. By virtue of the controllable electrical supply providing a condition of substantially zero voltage, the second primary switch can be closed without arcing, again reducing contact wear, increasing the lifetime of the switch, reducing the associated switch maintenance costs, and enabling the size and mass of the switch to be decreased, and its speed of operation to be increased.

Accordingly, this enables the first current to be transferred from the first current path to the second current path, for example in a tap changing transformer, without arcing across the first or second primary switches. By way of a reverse operation, the first current can also be transferred from the second current path to the first current path.

Preferably the or each semiconductor switching means comprise one or more thyristors. These may be provided as thyristor pairs comprising a first thyristor and a second thyristor arranged in parallel, such that the first thyristor provides a forward current path in one direction and the second thyristor provides a forward current path in the opposite direction.

A snubber may be provided across the or each thyristor pair, to limit the rate of change of the bias voltage applied to each thyristor when leaving conduction, to avoid re-triggering the device.

Preferably the or each primary switch comprises a mechanical switch.

Preferably the electrical device is an on-load tap changing transformer, and the first and second primary switches are diverter switches of the transformer. The first and second current paths may further include one or more tap selector switches.

The electrical device may further comprise mechanical switches within the diversionary path, in series with each semiconductor switching means, to mitigate closed circuit failure of any of the semiconductor switching means or the controllable electrical supply. The electrical device may further comprise a device (e.g. an inductor and/or resistor and/or non-linear device) arranged to limit the inter-tap short circuit current occurring if any of the semiconductor switching means were to fail in the short circuit state.

Preferably the controllable electrical supply comprises: an electrical source; an amplifier having two output terminals (preferably non-ground-referenced) and comprising a plurality of semiconductor devices; and control logic arranged to operate the amplifier such that it can selectively present both current and voltage source behaviour at the terminals.

The amplifier may be a switched mode amplifier, although other types and configurations of amplifier, such as linear amplifiers, are also possible. In practical embodiments, a switch-mode design might be favoured for reasons of power efficiency. However, since the duration of amplifier operation may be brief and the power and total energy processed is small, the impact of amplifier efficiency on overall efficiency may be very small, and consequently a faster less-efficient linear amplifier may be employed in order to implement faster acting control, unimpeded by a switching period limitation. For example, a linear amplifier with good zero-crossing performance, such as a Class AB amplifier, may be preferred.

If the amplifier is a switched mode amplifier, then it may comprise an H-bridge configuration, and the amplifier and control logic may be arranged to provide hysteresis current control.

For switched mode and other types of amplifier, the amplifier and control logic may be arranged to provide linear voltage control.

Preferably the electrical device further comprises: an inductor in series with a terminal of the amplifier; and a diverter path across the load inductor and an output of the amplifier, the diverter path comprising a voltage-defining impedance. The voltage-defining impedance may be provided by a capacitor and/or a resistor, for example. Such a resistor may be a parasitic resistance. Particularly preferably the voltage-defining impedance is provided by a capacitor and resistor in series.

Preferably the control logic comprises a current control loop arranged to: derive a current error signal directly from the current flowing in the first or second primary switches or indirectly from the load current and the current through the terminals of the amplifier; and provide a voltage output across the output terminals of the amplifier so as to alter the current through the terminals of the amplifier; such that the current error signal is substantially zero.

The term “derive” as used herein should be interpreted broadly, to encompass direct measurement of the quantity in question, and also indirect acquisition of the said quantity, for example by digital or analogue processing.

Preferably the control logic comprises a voltage control loop arranged to: obtain the voltage across a primary switch; derive a voltage control output signal from the voltage across the said primary switch, thereby providing an additional current demand on the current control loop; and inject current into the voltage-defining impedance so as to render the voltage across the said primary switch substantially zero.

Preferably the control logic further comprises a voltage control loop compensator, such as a first order low pass filter with a cut-off frequency of approximately 20 times the line frequency, for example. In the case of a 50 Hz line frequency, this would give a cut-off frequency of approximately 1 kHz. Other voltage control loop compensators will be apparent to those skilled in the art.

Preferably the electrical source is operable to provide a voltage greater than the forward voltage drop of one of the said thyristors, although those skilled in the art will appreciate that selecting a DC voltage much greater than three times the forward voltage drop would provide little operational benefit in terms of the speed of current control but would require the controllable electrical supply to handle a greater instantaneous power and therefore necessitate larger and more expensive components within the sub-circuit of the controllable electrical supply.

Preferably the semiconductor devices of the amplifier are MOSFET devices. However, alternative devices are also possible, such as insulated-gate bipolar transistors (IGBTs).

According to a second aspect of the present invention there is provided a method of operating a mechanical switch in an electrical device, the method comprising: providing a first current path having a primary switch therein, coupled to an electrical supply such that a first electrical current flows through the primary switch; providing a diversionary current path having semiconductor switching means and a controllable electrical supply therein, the diversionary current path being operable to bypass the primary switch; bringing the semiconductor switching means into a state of conduction; supplying a second current from the controllable electrical supply whilst the semiconductor switching means are in the state of conduction such that substantially zero current flows through the primary switch; and then opening the primary switch under a condition of substantially zero load current.

Preferably the primary switch is a first primary switch and the semiconductor switching means is a first semiconductor switching means, and the method further comprises: providing a second current path having a second primary switch therein, the second current path being switchable into electrical connection with the electrical supply; providing second semiconductor switching means in the diversionary current path and connected to the second current path, the second semiconductor switching means being operable to bypass the second primary switch; bringing the second semiconductor switching means into a state of conduction; imposing a voltage from the controllable electrical supply whilst the second semiconductor switching means are in the state of conduction, the voltage being such as to cause substantially zero voltage across the second primary switch when the second primary switch is open; and then closing the second primary switch under a condition of substantially zero voltage.

The method may then comprise disabling the controllable electrical supply and thereby causing the first electrical current to flow through the second primary switch.

Accordingly, this enables the first current to be transferred from the first current path to the second current path, for example in a tap changing transformer, without arcing across the first or second primary switches. By way of a reverse operation, the first current can also be transferred from the second current path to the first current path.

Preferably each semiconductor switching means comprises a thyristor pair comprising a first thyristor and a second thyristor arranged in parallel, such that the first thyristor provides a forward current path in one direction and the second thyristor provides a forward current path in the opposite direction. In the case of an on-load tap changing transformer, thyristor commutation processes may be used to ensure that an inter-tap short circuit cannot be formed through the first and second semiconductor switching means. There are three particularly noteworthy examples of thyristor commutation processes, as follows:

In the first example, the method comprises, whilst the first electrical current is positive: bringing a first thyristor in the first semiconductor switching means into a state of conduction in a forward direction; and when the first electrical current makes its next zero crossing, observing/measuring the voltage across the first thyristor in the first semiconductor switching means in order to ensure that it has become fully blocking before bringing a first thyristor in the second semiconductor switching means into conduction in a forward direction. This ensures that both semiconductor switching means do not conduct at the same time.

Alternatively, in the second example, the method comprises: bringing a first thyristor in the first semiconductor switching means into a state of conduction in a forward direction; and then bringing a first thyristor in the second semiconductor switching means into a state of conduction in a forward direction such that the first thyristor in the first semiconductor switching means becomes reverse biased and enters the blocking state; and then applying a triggering signal to the second thyristor in the second semiconductor switching means such that it provides a forward conduction path when the first electrical current makes its next zero crossing.

In the third example, the method comprises: bringing a first thyristor in the first semiconductor switching means into a state of conduction in a forward direction; and then applying a triggering signal to a first thyristor in the second semiconductor switching means such that it provides a forward conduction path when the first electrical current makes its next zero crossing.

It will be appreciated that the above three examples of thyristor commutation processes may each be performed in a reverse manner, i.e. going from the second semiconductor switching means to the first semiconductor switching means.

According to a third aspect of the present invention there is provided a controllable electrical supply comprising: an electrical source; an amplifier having two output terminals and comprising a plurality of semiconductor devices; and control logic arranged to operate the amplifier such that it can selectively present both current and voltage source behaviour at the terminals.

The amplifier may be a switched mode amplifier, although other types and configurations of amplifier, such as linear amplifiers, are also possible, as previously discussed.

If the amplifier is a switched mode amplifier, then it may comprise an H-bridge configuration, and the amplifier and control logic may be arranged to provide hysteresis current control.

For switched mode and other types of amplifier, the amplifier and control logic may be arranged to provide linear voltage control.

Preferably the controllable electrical supply further comprises: an inductor in series with a terminal of the amplifier; and a diverter path across the inductor and an output of the amplifier, the diverter path comprising a voltage-defining impedance. The voltage-defining impedance may be provided by a capacitor and/or a resistor, for example, as previously discussed.

Preferably the control logic comprises a current control loop arranged to: derive a current error signal from a load current and the current through the terminals of the amplifier; and provide a voltage output across the output terminals of the amplifier so as to alter the current through the terminals of the amplifier; such that the current error signal is substantially zero.

Preferably the control logic comprises a voltage control loop arranged to: obtain a voltage error signal from one or more external voltage measurements; derive a voltage control output signal from the voltage error signal thereby providing an additional current demand on the current control loop; and inject current into the voltage-defining impedance so as to counteract or nullify an external voltage.

Preferably the control logic further comprises a voltage control loop compensator, such as a first order low pass filter with a cut-off frequency of approximately 20 times the line frequency, for example. In the case of a 50 Hz line frequency, this would give a cut-off frequency of approximately 1 kHz. Other voltage control loop compensators will be apparent to those skilled in the art.

Preferably the semiconductor devices of the amplifier are MOSFET devices. However, alternative devices are possible, such as insulated-gate bipolar transistors (IGBTs).

With all the aspects of the invention, preferable, optional, features are defined in the dependent claims.

### BRIEF DESCRIPTION OF THE DRAWINGS

Embodiments of the invention will now be described, by way of example only, and with reference to the drawings in which:

FIG. 1 illustrates a classic mechanical on-load tap changer;

FIG. 2 illustrates two parasitic inductances incorporated into the branches of a simplified OLTC diverter;

FIG. 3 illustrates a new OLTC circuit design according to an embodiment of the present invention;

FIG. 4 illustrates the sequence of a “tap-up” operation under the new OLTC scheme, with:

FIG. 4(a) showing a timing diagram in which the shaded areas indicate that the corresponding component is conducting the load current,

FIG. 4(b) illustrating (in the heavier line weight) a first current path when a first primary switch, S_{L}, is in conduction,

FIG. 4(c) the current path when a first diversionary path is in conduction and the first primary switch is still closed,

FIG. 4(d) the current path as in FIG. 4(c) with the first primary switch open,

FIG. 4(e) the current path when a second diversionary path is in conduction and the first primary switch and a second primary switch, S_{R}, are both open,

FIG. 4(f) the current path as in FIG. 4(e) with the first primary switch open and the second primary switch closed, and

FIG. 4(g) a second current path when the second primary switch is in conduction;

FIG. 5 illustrates a practical implementation of a controlled source;

FIG. 6 illustrates a complete diverter implementation including a practical implementation of a controlled source;

FIG. 7(a) illustrates a sequence of events in an example of a thyristor commutation process which avoids an inter-tap short circuit;

FIG. 7(b) illustrates a sequence of events in an example of a ‘forced’ thyristor commutation process;

FIG. 7(c) illustrates a sequence of events in an example of a ‘natural’ thyristor commutation process;

FIG. 8 illustrates a proposed diverter control system; and

FIG. 9 provides some simulation results for a single “tap-up” operation.

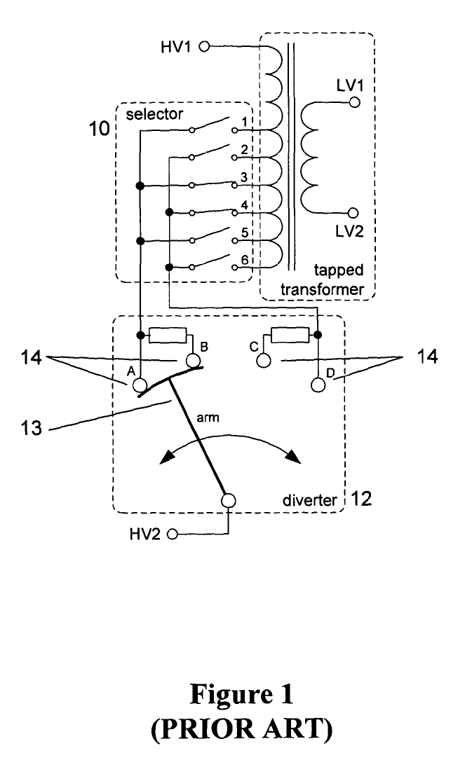

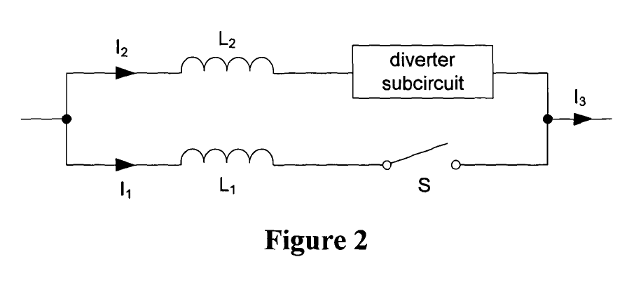

In the figures, like elements are indicated by like reference symbols throughout.

### DETAILED DESCRIPTION OF PREFERRED EMBODIMENTS

The present embodiments represent the best ways known to the applicants of putting the invention into practice. However, they are not the only ways in which this can be achieved.

Although the present embodiments will be discussed primarily with respect to OLTC transformers, it is to be emphasised that the principles are equally applicable to other mechanical switching devices in which the switching operation is performed whilst the switch contacts are under electrical load.

Moreover, although in certain embodiments numerical values of components are given, these are by way of example only; the principles can readily be extended to both lower- and higher-power applications using other components having appropriate values.

The present new OLTC design offers several improvements over a classic OLTC scheme and is competitive with new semiconductor assisted schemes. The new scheme offers:
Low loss operation—The new scheme requires no semiconductors or wound components in the steady-state current carrying path, resulting in very low steady-state power loss comparable to that of a classic OLTC. No other semiconductor assisted OLTC scheme offers the same minimum power loss characteristics.
Fast operation—The new scheme is potentially capable of producing a tap change every current zero crossing. This is far superior to the classic OLTC scheme and competitive with the performance that is technically possible from existing semiconductor assisted OLTC designs.
A high number of operations between maintenance cycles—The new scheme is capable of reducing arcing at mechanical switching contacts to a very low level, resulting in a minimum of contact wear, in turn resulting in significant lifetime advantages over classic OLTC designs.
Competitive cost, size and maintenance demands—The new scheme is comparable in size and complexity to existing semiconductor assisted OLTC schemes. It will occupy significantly less space than a classic OLTC due to a much reduced mechanical system. Maintenance demands are forecast to be significantly less than for a classic OLTC and comparable to existing semiconductor assisted OLTC schemes.

A new active OLTC scheme is presented here. It differs from that of [1], [3] and [4] by the fact that it does not require any extra components in the load current path during steady state operation and can be made tolerant of any internal semiconductor failure.

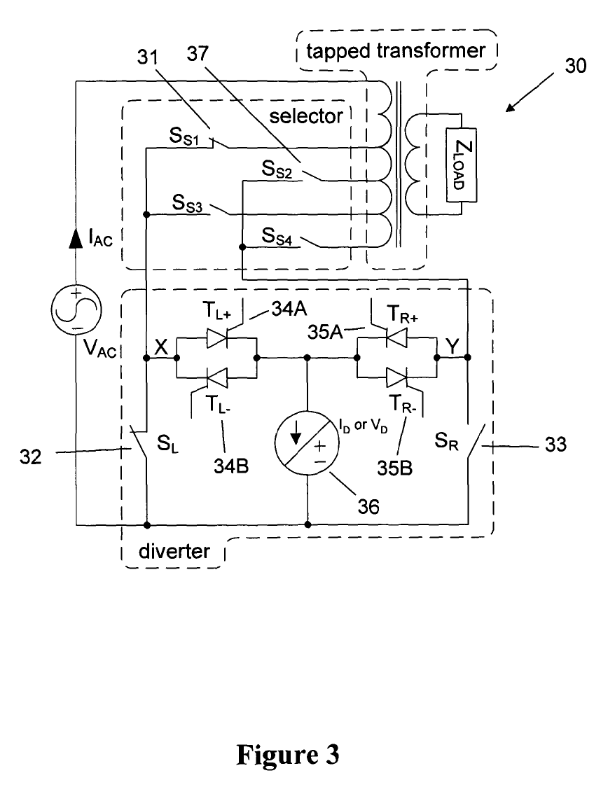

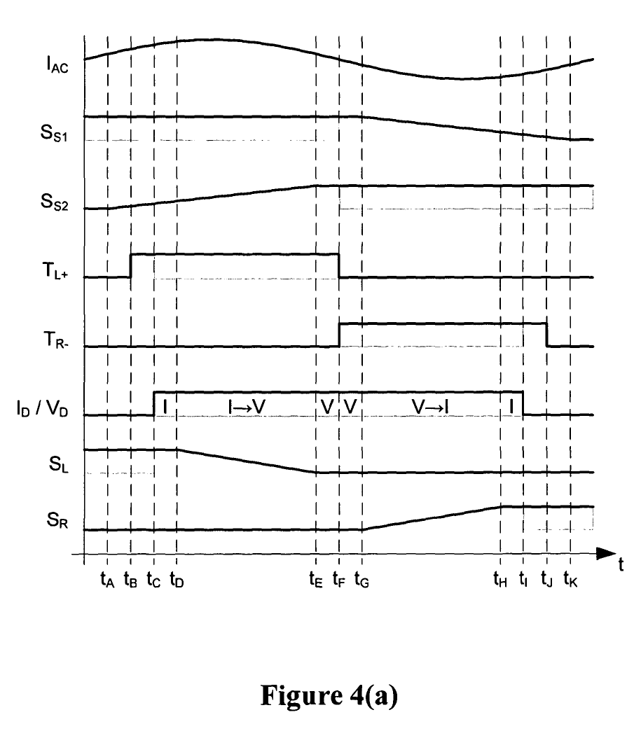

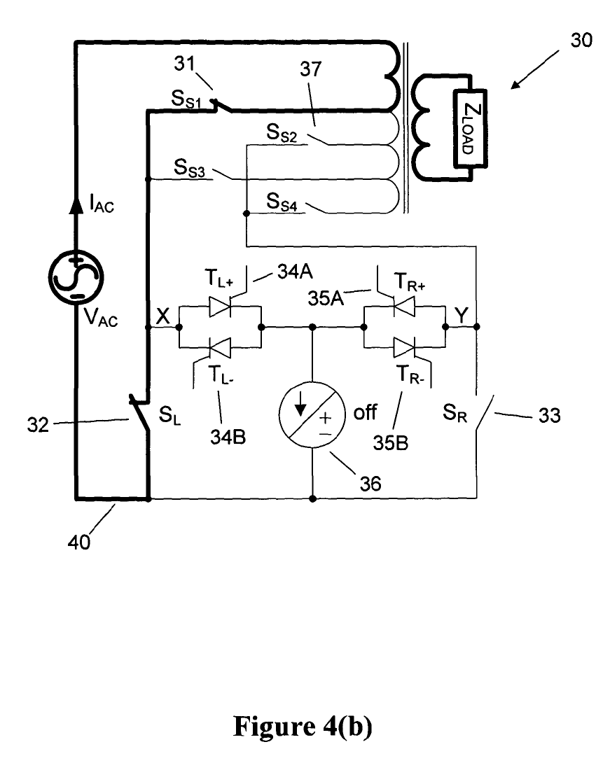

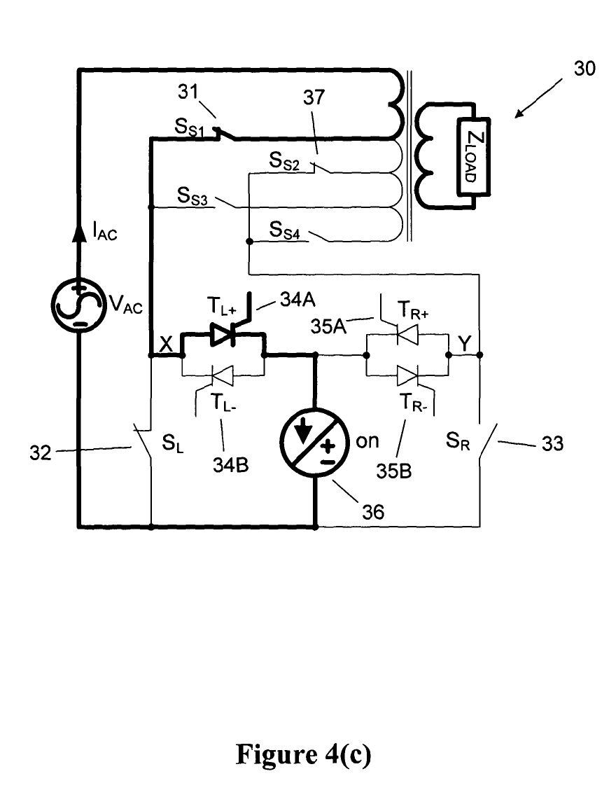

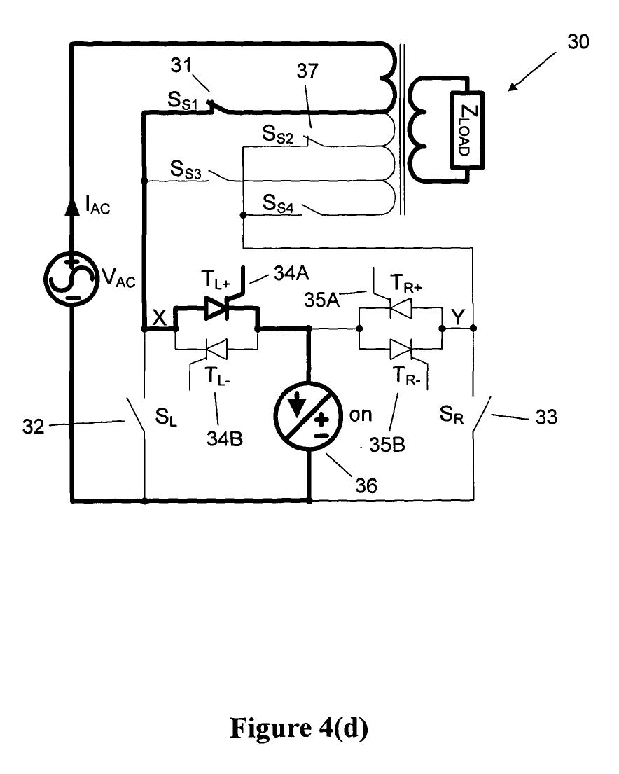

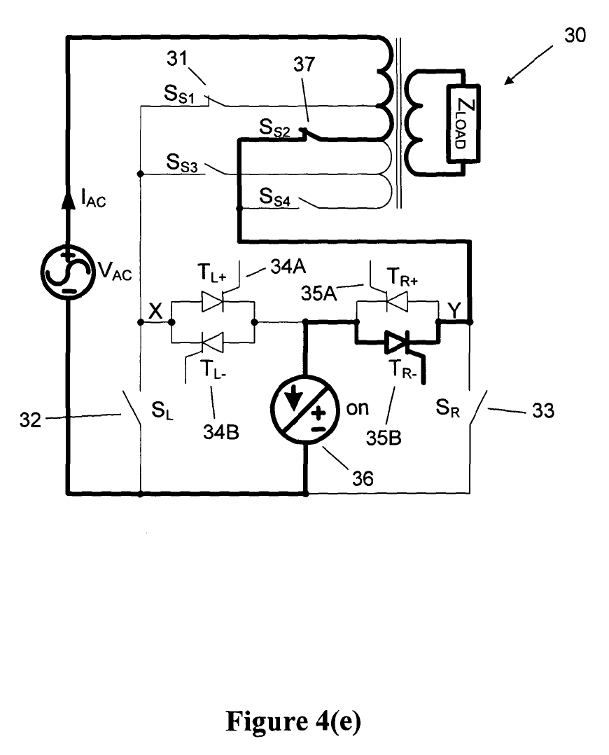

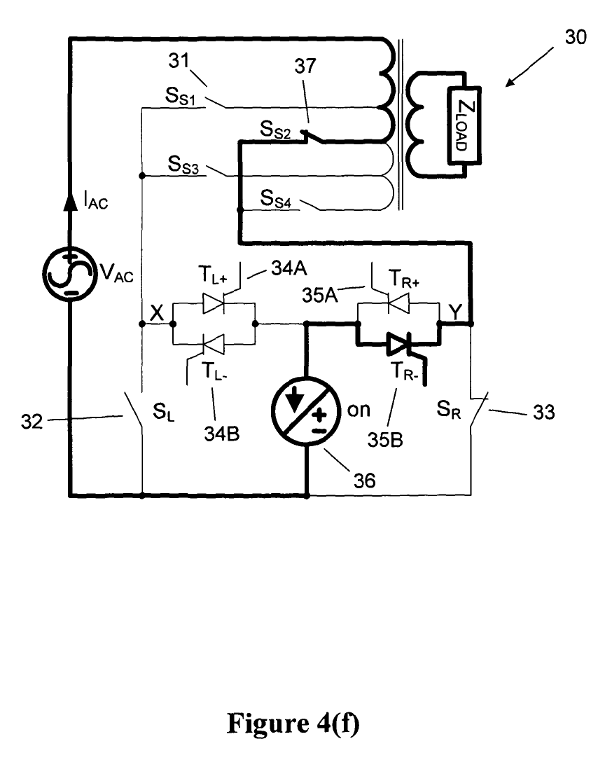

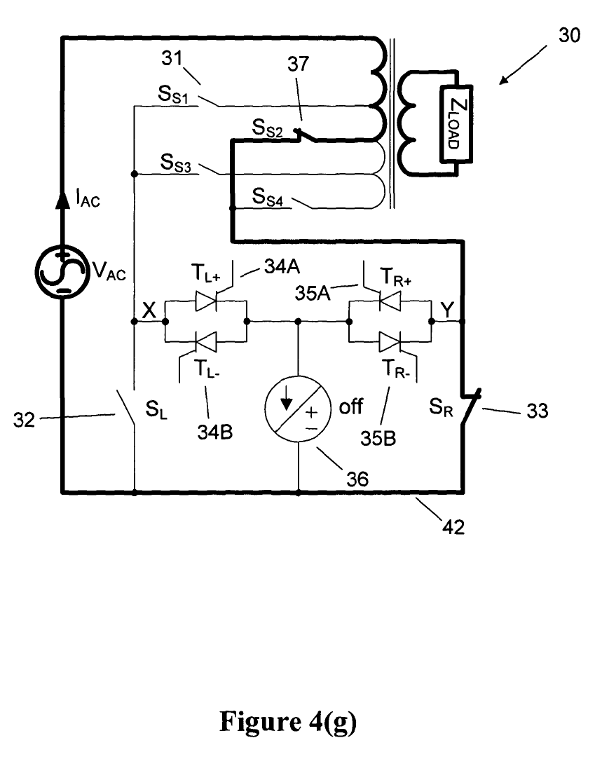

FIG. 3 shows the new OLTC design at its most fundamental level for a single phase, having a diverter section, a selector section and a tapped transformer. By way of an overview, the OLTC apparatus 30 comprises a first current path (e.g. as indicated by the emboldened path 40 in FIG. 4(b)) having a first primary mechanical switch 32 therein, and a second current path (e.g. as indicated by the emboldened path 42 in FIG. 4(g)) having a second primary mechanical switch 33 therein. The first and second current paths are coupled to an AC electrical supply (V_{AC}) which supplies an alternating load current around the first or second current paths, depending on the arrangement of other switches (e.g. transformer tap selector switches 31, 37) in the apparatus.

The OLTC apparatus further comprises a diversionary current path containing a controllable electrical supply 36 (which may also be referred to as a “controlled source” herein), and having a first branch containing first semiconductor switching means 34A and 34B, and a second branch containing second semiconductor switching means 35A and 35B. The first semiconductor switching means 34A and 34B are operable to bypass the first primary switch 32, and the second semiconductor switching means 35A and 35B are operable to bypass the second primary switch 33. The first and second semiconductor switching means may be provided by thyristor pairs, or other semiconductor switching devices as those skilled in the art will appreciate.

As will be described in further detail below, the controllable electrical supply 36 is operable to set up conditions of zero current and zero voltage such that the primary mechanical switches 32, 33 can be opened and closed without arcing, whilst the load current is maintained, uninterrupted, via the diversionary path.

Viewed another way, before a mechanical switch is opened, the controllable electrical supply 36 is operable such as to effectively make the diversionary current path more ‘favourable’ than the first current path, so that the load current diverts into this path, thus providing a condition of zero current through the switch.

For a multi-phase system the system would be repeated across all phases and all circuits operated concurrently. As for most OLTC schemes, the design can be separated into a selector section and a diverter section. The selector section is capable of connecting any odd-numbered tap to the left-hand side, and any even-numbered tap to the right-hand side. As in the classic OLTC, the schemes presented in [1] and [2] and most other tap changing schemes the diverter operates by transferring the load current between sides; each transition allows a different tap to be selected, as long as the new tap is on the opposing ‘side’. As for the classic OLTC, the selector contacts are never required to break or make current; this function is handled by the diverter section. In the embodiment illustrated in FIG. 3, the diverter section of the new OLTC design consists of two mechanical switches 32, 33, two sets of anti-parallel thyristors 34, 35, and a controllable electrical supply 36 which can be operated as either a current source or a voltage source (labelled ‘I_{D} or V_{D}’ in FIG. 3).

Specification of Example Components within the New OLTC Design

It may be helpful to consider the specification requirements for example components within the new design before a discussion of the tap change method, in order to gain an appreciation of the reasoning behind the design and why the new OLTC scheme potentially offers a competitive alternative to existing schemes. Figures contained in the following specifications are generated by considering a single phase of a 2 MVA 11 kV primary-side OLTC. Fault currents are substantially larger than the rated load current of the transformer and for this illustration are taken to be 10 times the rated load current.
Selector switches (S_{S1} to S_{Ss4}) (e.g. switches 31 and 37)—Ideally capable of rapid operation in the sub cycle range (<20 ms). Must be rated to carry the maximum load current (60 A_{RMS}). There is no requirement to break the load current (as for the classic OLTC). When open, they must be able to block the inter-tap voltage (1100 V_{RMS} for a 10% tap). Under fault conditions this component must be capable of carrying the fault current until standard network protection mechanisms can be activated.
Diverter switches S_{L} and S_{R} (i.e. primary switches 32 and 33)—Ideally capable of rapid operation in the sub half-cycle range (<10 ms). Must be rated to carry the maximum load current. There is no requirement to break the load current (unlike for the classic OLTC). When open, they must be able to block the inter-tap voltage. Under fault conditions this component must be capable of carrying the fault current until standard network protection mechanisms can be activated. Furthermore this component may be required to close under fault conditions to protect the semiconductor devices used within the design.
Thyristor pairs T_{L+}, T_{L-} and T_{R+}, T_{R-} (i.e. thyristors 34A &34B, and 35A & 35B)—Must be capable of blocking the inter-tap voltage continuously. Must be capable of conducting the load current, but only during tap change operations (i.e. low duty cycle demand). Under fault conditions these components must be capable of carrying the fault current for a short period of time until either diverter switch 32, 33 (S_{L} or S_{R}) can be closed (ideally this would occur within 10 ms of a fault current being detected).
Controlled source 36 (I_{D} or V_{D})—Must be capable of generating a current equal to the load current, but only during tap change operations (i.e. low duty cycle demand). Must be capable of generating a voltage greater then the forward voltage drop of the thyristor pairs 34, 35 (approximately 2.5 V). Under fault conditions the controlled source 36 must be capable of carrying the fault current for a short period of time until either diverter switch 32, 33 (S_{L} or S_{R}) can be closed (ideally this would occur within 10 ms of a fault current being detected).

From the above specifications, the maximum instantaneous power output of the controlled source in the 2 MVA 11 kV OLTC case is approximately 250 W. Therefore the controlled source specifications demand only a small, low-power subcircuit; whilst the source conducts the full load current it has a very low terminal voltage.

Indeed, the overall circuit topology and controlled source design may be such that the controlled source is never required to generate or tolerate a terminal voltage greater than two to three times the forward voltage drop of a thyristor semiconductor device (<8 V). The controlled source is never exposed to the full line voltage (>11 kV) or the inter-tap voltage (>100 V). This design feature allows the design of a controlled source that is simple, low cost and compact.

### Steps Required to Perform a Tap Change in the New OLTC Scheme

FIG. 4 illustrates how a single tap-up operation may be performed under the new OLTC scheme. The load current path is marked by the heavier line weight for four distinct phases of the tap change operation. It is important to appreciate that the tap change is designed to be ‘fast’ in the sense that it will occur in a time comparable with the period of the mains waveform (e.g. 20 ms in the case of a 50 Hz mains waveform). For such timescales simple on-off behaviour of a mechanical switch cannot be assumed. For example, a switch that moves from the current supporting on-state to the voltage supporting off-state will, if opened under a load current, move through an intermediate state where it is conducting through an arc between separated contacts. Once this arc is extinguished the switch will not necessarily be able to support the full-rated voltage of the switch until the contacts are fully separated and any ionised material has been removed from between them. Therefore all triggering of switches in the following discussion implies merely that the switch has begun to move out of its present state (open or closed), not that it has entered the subsequent state (closed or open).

FIG. 4(b) shows the OLTC operating in steady state on tap 1. Here, the selector switch 31 (S_{S1}) and the left hand diverter switch 32 (S_{L}) are closed and conducting the load current. As all other switches are open, no semiconductor device conducts a current or has a voltage applied across it. The direction of current flow is taken as positive in this and subsequent figures. Refer to FIG. 4(a) for a timing diagram detailing the following sequence.
1. At t=t_{A} the selector switch for tap 2 (S_{S2}) 37 is triggered to begin closing in preparation for the next tap.
2. At t=t_{B} gate current is applied to the left hand positive thyristor 34B (T_{L+}).
3. At t=t_{C} the controlled source 36 is enabled and set such that the diverter current I_{D} is equal to the load current, therefore the left switch 32 (S_{L}) current is equal to zero. The current flow is now as shown in FIG. 4(c). Gate current to T_{L+} 34B is removed but the thyristor continues to conduct the load current.
4. At t=t_{D} the left hand diverter switch 32 (S_{L}) is triggered to begin opening as it is no longer required to conduct current. The switch will open under a condition of zero current due to the action of the controlled source specified previously.
5. At t=t_{E} the left hand switch has reached a guaranteed fully open state. The current flow is now as shown in FIG. 4(d).
6. At the instant of current reversal (t=t_{F}) T_{L+} 34B stops conducting and a pulse of gate current is applied to the right hand negative thyristor (T_{R-}) 35B. This causes the load current to transfer to the right hand side of diverter circuit and assume the path shown in FIG. 4(e).
7. At t=t_{F} the controlled source 36 is set to generate a voltage (V_{D}) such that the voltage across the right hand switch 33 is zero. At this point the OLTC is operating on tap 2 (37).
8. At t=t_{G} the right hand diverter switch 33 (S_{R}) is triggered to close. The switch S_{S1} 31 can be triggered to open as it no longer supports the load current.
9. At t=t_{H} S_{R} 33 has reached a guaranteed fully closed state under a condition of zero voltage specified previously, as shown in FIG. 4(f).
10. At t=t₁ the controlled source 36 is disabled allowing current to divert into S_{R} 33.
11. At t=tⱼ T_{R-} 35B is no longer required to carry the load current. Gate current is removed and the thyristor 35B and will drop out of conduction once the load current has fully diverted into S_{R}.
12. At t=t_{K} S_{S1} 31 has fully opened and the OLTC has entered a steady state condition on tap 2 (37). The current path is now the emboldened path 42 shown in FIG. 4(g).

Using a similar process a right-to-left current transfer can be completed allowing a subsequent tap-up or tap-down operation. This OLTC scheme provides arcless operation of all its mechanical switches; a switch is never opened whilst it is conducting current and never closed while it has a voltage imposed across it. In the ideal case contact damage caused by arcing is eliminated, resulting in greatly enhanced contact life over the classic OLTC.

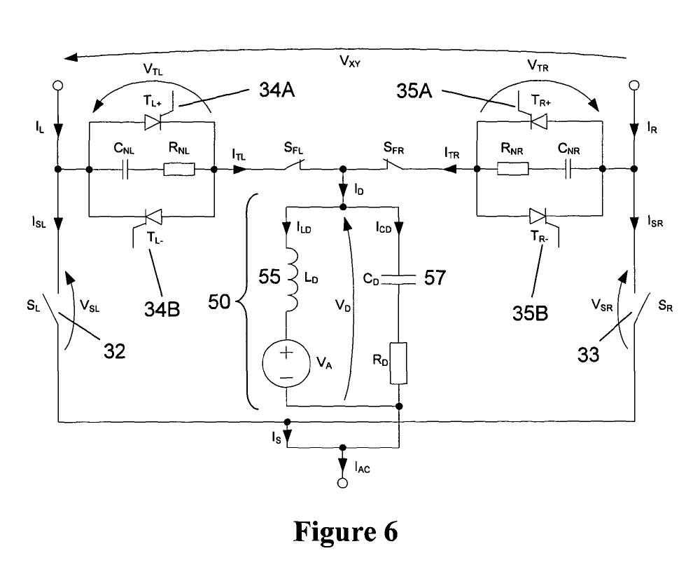

Closed circuit failure of any number of thyristors and/or of the current source can be mitigated by inserting two extra mechanical switches into the design, one in series with each thyristor pair (e.g. switches S_{FC} and S_{FR} in FIG. 6). Each of these switches is kept in the closed position during tap change operations and is never opened or closed under load during normal operating conditions. Upon a device failure both switches would be opened to remove the affected portion of the circuit from the system, allowing the system to continue to operate as a fixed transformer. These switches must be rated to interrupt an inter-tap fault current. These switches would not incur any extra power loss under steady-state conditions as they are not in the steady-state load current path.

Potential Issues with the New OLTC Scheme

There are two issues that arise after considering the OLTC design outlined in the previous section. Firstly, the controlled source is set to act as a current source whilst a diverter switch 32, 33 (S_{L} or S_{R} in FIG. 4) is opening. Therefore there exists a period of time in every tap changing operation (between time t_{D} and t_{F} in FIG. 4(a)) where the load current is entirely supported by the controlled source 36. By definition the load current during this time is equal to the current source setting and hence is fixed (i.e. I_{AC}=I_{D}). In this case a change in the load characteristics which would normally cause a change in the load current cannot do so; the current source would act to force a particular load current. This is an undesirable property of the system, instead it would be preferable to allow a change in load characteristics to result in a change in load current, i.e. design the system such that the OLTC appears as a voltage source at all times. A method of operating the controlled source such that voltage source behaviour is maintained is given later.

Secondly, the left-to-right or right-to-left current ‘handover’ occurring at the zero crossing of the load current (at time t_{F} in FIG. 4(a)) is potentially problematic. Under a subset of operating scenarios a mis-handled current handover could lead to an inter-tap short circuit for one half of the mains cycle. This can be illustrated by considering the inter-tap voltage V_{XY}=V_{X}−V_{Y} (see nodes X and Y on FIG. 4) at the moment of load current zero crossing. This voltage is applied across the thyristor pairs T_{L+}, T_{L-} (34) and T_{R+}, T_{R-} (35).

For the following, assume that a tap change (up or down) is to be made between tap 1 and tap 2, i.e. S_{S1} 31 and S_{S2} 37 are closed and all other selector switches are open at the instant of current zero crossing. Also assume that a positive to negative zero crossing is being considered, i.e. for a tap up operation the current transfer is to be made between T_{L+} 34A and T_{R-} 35B and for a tap down operation the current transfer is to be made between T_{R+} 35A and T_{L-} 34B. Four possibilities must be considered:
1. Tap-up operation (current handover from left to right) with a leading power factor—As the source voltage lags the load current, V_{XY} is negative at the moment of current zero crossing. T_{L+} 34A will be instantly reversed biased by the inter-tap voltage when it drops out of conduction at the current zero crossing. Thus no inter-tap short circuit path is generated and T_{R-} 35B may be supplied with trigger current before the zero crossing in order to guarantee smooth commutation of the load current.
2. Tap-up operation (current handover from left to right) with a lagging power factor—As the source voltage leads the load current, V_{XY} is positive at the moment of current zero crossing. Should T_{R-} 35B be triggered before T_{L+} 34A drops out of conduction, a short circuit will exist and an inter-tap short circuit current will be established through T_{L+} 34A and T_{R-} 35B. In this case it is necessary to wait until T_{L+} 34A has left conduction before T_{R-} 35B is triggered. This may be achieved by observing the voltage V_{TL} and waiting until a suitable reverse recovery voltage is detected (signifying that T_{L+} 34A has become fully blocking) before triggering T_{R-} 35B.
3. Tap-down operation (current handover from right to left) with a leading power factor—This case can be thought of as the mirror image of case 2. Here, the source voltage lags the load current and V_{XY} is negative at the moment of current zero crossing. Should T_{L-} 34B be triggered before T_{R+} 35A drops out of conduction, a short circuit will exist and an inter-tap short circuit current will be established through T_{L-} 34B and T_{R+} 35A. In this case it is necessary to wait until T_{R+} 35A has left conduction before T_{L-} 34B is triggered. This may be achieved by observing the voltage V_{TR} and waiting until a suitable reverse recovery voltage is detected (signifying that T_{R+} 35A has become fully blocking) before triggering T_{L-} 34B.
4. Tap-down operation (current handover from right to left) with a lagging power factor—This case can be thought of as the mirror image of case 1. Here, the source voltage leads the load current and V_{xy} is positive at the moment of current zero crossing. T_{R+} 35A will be instantly reversed biased by the inter-tap voltage when it drops out of conduction at the current zero crossing. Thus no inter-tap short circuit path is generated and T_{L-} 34B may be supplied with trigger current before the zero crossing in order to guarantee smooth commutation of the load current.

Care should be taken with current handover between thyristor pairs 34, 35. In cases 2 and 3 it is necessary to monitor the voltage across the outgoing thyristor pair in order to time the handover correctly. This may also be necessary for cases 1 and 4 when the power factor is close to unity because the time available to trigger the incoming thyristor pair before the next current zero crossing will become small.

It should be noted that in all cases the rate of change of the bias voltage applied to the thyristor leaving conduction should be limited to avoid re-triggering the device. This implies that a form of snubber circuit may be required across the thyristor pairs, depending on the parameters of the chosen devices. A suitable choice of snubber circuit also reduces the timing constraints for the thyristor triggering system. A snubber circuit provides a path for the load current around the zero crossing allowing a small delay whilst the thyristor leaving conduction fully recovers and the thyristor entering conduction becomes fully conducting.

### Implementation of the Controlled Source

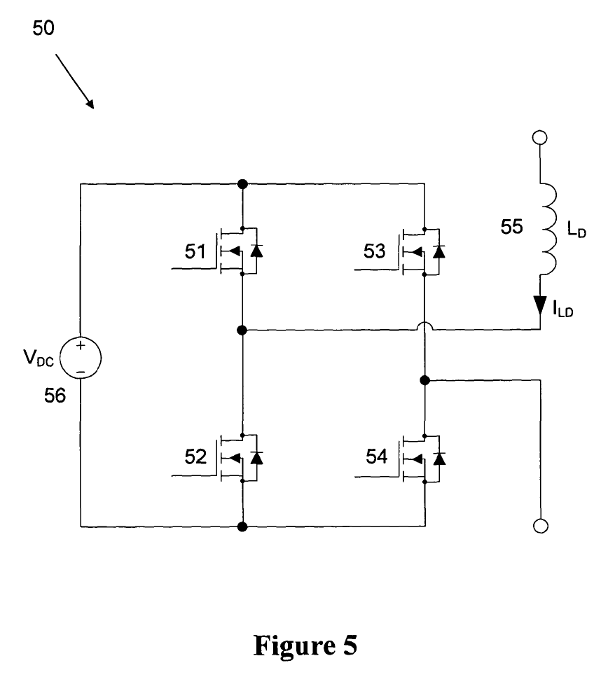

A practical implementation of the controlled source 36 of FIG. 3 is given in FIG. 5 (identified as circuit 50). Current source behaviour is obtained by suitable feedback control of the duty cycle of the ‘H-bridge’ switches 51 to 54 (depicted as MOSFET devices in FIG. 5) acting to impose a voltage across an inductor 55 (L_{D}). For the new OLTC scheme considered here a simple ‘hysteresis controller’ is capable of obtaining tight regulation of the current I_{D} around a set point. As those skilled in the art will appreciate, a hysteresis controller is a non-linear control method particularly suited to this application due to the inherent switch mode nature of the controlled source. Under normal operating conditions a hysteresis controller provides both guaranteed stability and guaranteed tracking of the error current within the bands set by the relay, resulting in an inner control loop possessing very high bandwidth approaching that of the relay switching frequency.

This arrangement is capable of providing the current source behaviour during the period t_{C} to t_{E} (see FIG. 4(a)); however it is not capable of providing a defined terminal voltage as required during the period t_{F} to t_{H}. A ‘dual purpose’ source that is capable of providing either current source like or a voltage source like behaviour during a tap change operation is therefore desired. Such behaviour is possible with the addition of two further components to the circuit of FIG. 5, producing the complete diverter implementation shown in FIG. 6 (which corresponds to the diverter section of FIG. 3).

Instead of a switched mode amplifier such as the H-bridge arrangement illustrated, other amplifiers such as linear amplifiers may alternatively be used as the active element within the controlled source. As those skilled in the art will appreciate, the use of a linear amplifier has both advantages and disadvantages when compared to a switched mode implementation. A linear amplifier may reduce or eliminate ripple currents and voltages inherent in switch mode designs, but incur additional power loss in the active devices (MOSFETs, IGBTs etc), resulting in reduced efficiency of the controlled source. It should also be noted that a linear amplifier would preclude the use of a hysteresis inner current control loop and would instead require a possibly more complicated linear compensator design.

The control logic requirements for this circuit can be understood by considering diverter operation from left hand switch 32 (S_{L}) to right hand switch 33 (S_{R}) in FIG. 6 (refer to FIG. 4(a) for details of timing and FIGS. 4(b)-4(g) for the main current path in each case):
1. Current path as shown in FIG. 4(b) with S_{L} 32 closed and S_{R} 33 open: I_{SL}=I_{LEFT}≈I_{AC} as both thyristor pairs 34, 35 (T_{L+}, T_{L-} and T_{R+}, T_{R-}) are off and the voltage drop across S_{L} (32) is negligibly small. The H-bridge and control system 36 are not active as the diverter system is in a steady state condition on an odd tap.
2. Current path as shown in FIG. 4(c) with S_{L} 32 closed and S_{R} 33 open: I_{S} is set to 0 through the action of the H-bridge under hysteresis control. Therefore I^{SL}=0 as S_{R} is open and passes zero current. I_{CD} is small because V_{D}=V_{TL}, which is defined by the forward voltage drop of the conducting thyristor in pair 34 T_{L+}, T_{L-}. Due to the logarithmic dependency of thyristor forward voltage to forward current the rate of change of V_{D} is small and therefore the capacitive current flow driven by

$$\frac{d {V}_{D}}{d t}$$

is small.
3. Current path as shown in FIG. 4(d) with S_{L} 32 and S_{R} 33 open: With S_{L} 32 in the open state, the voltage across it is defined by the forward voltage of the conducting thyristor in the pair 34 T_{L+}, T_{L-} and the voltage across the capacitor C_{D} 57. At the instant of contact separation, the capacitor will exactly cancel the thyristor forward voltage due to the previous (pre-separation) action of the H-bridge. Once the contacts are separated, the control system should maintain zero voltage across the switch 32 via further action of the H-bridge (i.e. by modifying the charge on C_{D} 57).
4. Current path as shown in FIG. 4(e) with S_{L} 32 and S_{R} 33 open: The load current has been ‘handed over’ to the right side of the diverter circuit. The voltage across S_{R} 33 must now be driven to zero by the action of the H-bridge modifying the charge on C_{D} 57 to compensate for the voltage across the conducting thyristor in the pair 35 T_{R+}, T_{R+}, T_{R-}.
5. Current path as shown in FIG. 4(g) with S_{L} 32 open and S_{R} 33 closed: Once S_{R} 33 has fully closed the H-bridge circuit and controller may be disabled. The diverter system has entered a steady state condition on an even tap.

A tap change in the opposite direction (from right to left) is performed in a functionally identical manner but in the reverse direction.

### Detailed Thyristor Commutation Process

With respect to the thyristor commutation process described above, a tap change operation may, in effect, be fully described by four binary variables, namely:
1. Whether it is a tap-up or tap-down operation;
2. Commutation direction (left-to-right or right-to-left);
3. Zero crossing type (commutation performed at a positive-to-negative zero crossing of the load current or at a negative-to-positive zero crossing); and
4. Power factor (whether the load current leads or lags the supply voltage)

Exhaustively there are sixteen possible combinations of these variables, as set out in the following table:

| | | | | | V_{XY} at | | Potential |
|---|---|---|---|---|---|---|---|
| Case | Tap up | Commutation | Zero | Power | zero | | short |
| no. | or down | direction | crossing | factor | crossing | Thyristors | circuit? |
| 1 | up | L→R | pos→neg | lag | pos | T_{L+}→T_{R-} | yes |
| 2 | up | L→R | pos→neg | lead | neg | T_{L+}→T_{R-} | no |
| 3 | up | L→R | neg→pos | lag | neg | T_{L-}→T_{R+} | yes |
| 4 | up | L→R | neg→pos | lead | pos | T_{L-}→T_{R+} | no |
| 5 | up | R→L | pos→neg | lag | pos | T_{R+}→T_{L-} | no |
| 6 | up | R→L | pos→neg | lead | neg | T_{R+}→T_{L-} | yes |
| 7 | up | R→L | neg→pos | lag | neg | T_{R-}→T_{L+} | no |
| 8 | up | R→L | neg→pos | lead | pos | T_{R-}→T_{L+} | yes |
| 9 | down | L→R | pos→neg | lag | neg | T_{L+}→T_{R-} | no |
| 10 | down | L→R | pos→neg | lead | pos | T_{L+}→T_{R-} | yes |
| 11 | down | L→R | neg→pos | lag | pos | T_{L-}→T_{R+} | no |
| 12 | down | L→R | neg→pos | lead | neg | T_{L-}→T_{R+} | yes |
| 13 | down | R→L | pos→neg | lag | neg | T_{R+}→T_{L-} | yes |
| 14 | down | R→L | pos→neg | lead | pos | T_{R+}→T_{L-} | no |
| 15 | down | R→L | neg→pos | lag | pos | T_{R-}→T_{L+} | yes |
| 16 | down | R→L | neg→pos | lead | neg | T_{R-}→T_{L+} | no |

An inter-tap short circuit is possible if the incoming thyristor is triggered before the outgoing thyristor and the inter-tap voltage is in the same direction as the path created by the two thyristors.

Thus, two possible short circuit cases exist:
1. V is positive and T_{L+} and T_{R-} are both triggered at the same time
2. V_{XY} is negative and T_{L-} and T_{R+} are both triggered at the same time

The other two possibilities will not result in a short circuit:
1. V_{XY} is positive and T_{L-} and T_{R+} are both triggered at the same time
2. V is negative and T_{L+} and T_{R-} are both triggered at the same time

For the possible short circuit cases a method of ensuring that both thyristors do not conduct at the same time is desired. As the outgoing thyristor does not instantly recover its ability to block a reverse voltage upon leaving conduction, the rate of change of reverse voltage across it must be limited by the snubber and the triggering of the incoming thyristor must be delayed. A suitable delay is obtained by observing the voltage across the outgoing thyristor and waiting until it has reached a threshold that indicates that the thyristor has recovered properly before applying the trigger pulse to the incoming thyristor. It should be noted that the rate of change of voltage across the outgoing thyristor is limited by incorporating snubber components (see FIG. 6, C_{NL}, R_{NL}, C_{NR}, R_{NR}).

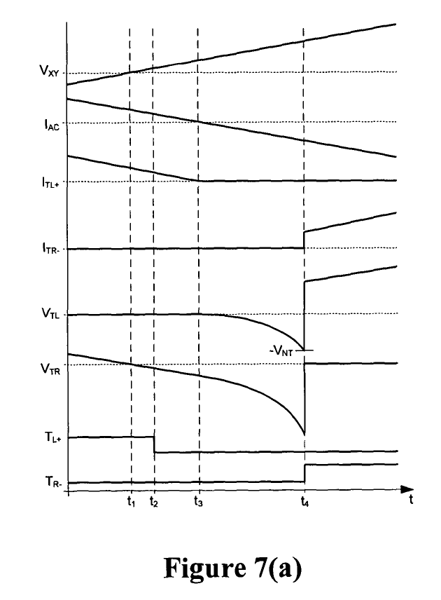

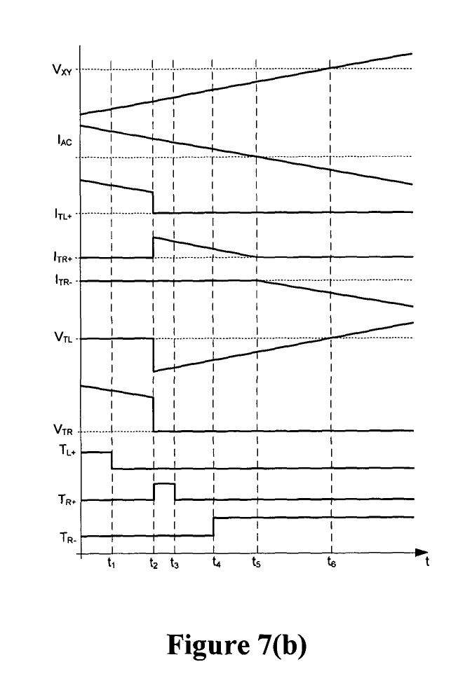

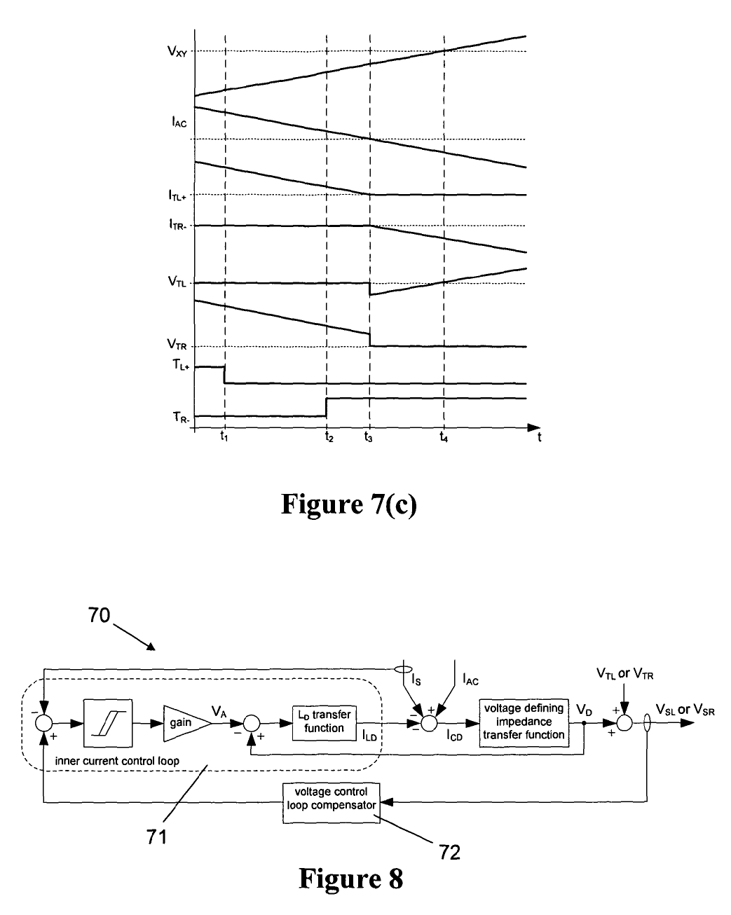

A sequence of events which avoids an inter-tap short circuit is depicted in FIG. 7(a), which shows a close-up around the load current zero crossing (therefore the currents appear as straight lines rather than sinusoids). The example illustrated is for a tap up, left to right, positive to negative zero crossing, lagging power factor operation (case no. 1 in the above table).

With reference to the sequence of events shown in FIG. 7(a) and the circuit quantities of FIG. 6:
t₁: the voltage zero crossing occurs before the current zero crossing (a lagging power factor)
t₂: the current zero crossing is approaching and so the trigger pulse is removed from the outgoing thyristor (T_{L+})
t₃: at the current zero crossing T_{L+} leaves conduction but is not fully reverse biased (in the blocking state); the current diverts into the snubber components C_{NL} and R_{NL} which begin charging
t₄: after a voltage has built up across the snubber to a level (V_{NT}) to a level at which it is ensured that T_{L+} has fully entered the blocking state, the incoming thyristor (T_{R-}) is triggered

Thus, during the period t_{d}=t₄−t₃ no thyristor is conducting and the load current is fully supported by the snubber components. However, because the load current is small near the zero crossing the total charge stored by the snubber during this time is also small. In a laboratory prototype system t_{d} was approximately 200 μs or 1/100 th of a cycle. |V_{NT}| was set at approximately 10 V.

In the cases where it is not possible to create an inter tap short circuit by premature triggering of the incoming thyristor, two different commutation methods are possible. One method may be described as producing ‘forced’ commutation, and the other as allowing ‘natural’ commutation. A sequence of events which produces forced commutation is depicted in FIG. 7(b). The example illustrated is for a tap up, left to right, positive to negative zero crossing, leading power factor operation (case no. 2 in the above table).

With reference to the sequence of events shown in FIG. 7(b) and the circuit quantities of FIG. 6:
t₁: the current zero crossing is approaching and so the trigger pulse is removed from the outgoing thyristor (T_{L+})
t₂: the thyristor T_{R+} is triggered, reverse biasing T_{L+} and forcing the load current to divert into T_{R+}
t₃: once T_{R+} is fully conducting, the trigger signal may be removed
t₄: before the zero crossing, the incoming thyristor (T_{R-}) is supplied with a trigger signal
t₅: at the zero crossing T_{R+} drops out of conduction and T_{R-} enters conduction
t₆: the voltage zero crossing occurs after the current zero crossing (a leading power factor)

A sequence of events which allows ‘natural’ commutation is depicted in FIG. 7(c). The example illustrated is for a tap up, left to right, positive to negative zero crossing, leading power factor operation (case no. 2 in the above table).

With reference to the sequence of events shown in FIG. 7(c) and the circuit quantities of FIG. 6:
t₁: the current zero crossing is approaching and so the trigger pulse is removed from the outgoing thyristor (T_{L+})
t₂: before the zero crossing, the incoming thyristor (T_{R-}) is supplied with a trigger signal
t₃: at the zero crossing T_{L+} drops out of conduction and T_{R-} enters conduction
t₄: the voltage zero crossing occurs after the current zero crossing (a leading power factor)

### The Diverter Controller

FIG. 8 shows the form of a proposed diverter control system 70 suitable for the switched mode amplifier implementation of FIG. 6. The control logic forming the system can be viewed as consisting of two loops, an inner non-linear hysteresis controller 71 acting on I_{LD} and an outer linear controller 72 working to regulate V_{SL}, or V_{SR} to zero.

### The Hysteresis Current Controller

A hysteresis current controller 71 is appropriate for use with a switched mode amplifier such as the H-bridge illustrated in FIG. 5. Ignoring the contribution of the outer control loop, a hysteresis controller relay acts to keep the quantity G_{P}I_{S} within a switching band (taken to be [−1/G_{P}, 1/G_{P}]). The switching frequency and output ripple current of the hysteresis controller is governed by the circuit value L_{D} and the two gains, the amplifier gain, G_{A} (equal to the amplifier supply voltage V_{DC}) and G_{P}, the relay pregain. There is a fundamental limitation on the maximum size of the inductor L_{D} because the H-bridge must act to force a sinusoidal current of the same magnitude and frequency as the load current; the inductor must be sized such that

$${L}_{D} < \frac{{V}_{DC} - {V}_{T}}{2 π {f}_{line} {I}_{LOAD ( pk )}} \qquad ( 1 )$$

A small inductance is desirable for physical size and cost reasons. However, choosing a very small inductor leaves the circuit vulnerable to the effects of parasitic resistances or variations in the thyristor 34, 35 forward voltage drop. Effectively there must be some voltage ‘headroom’ (defined by V_{DC}−V_{T}) available to allow variations in the practical circuit. Therefore a relatively arbitrary value of V_{DC} is taken for this analysis such that V_{DC}=2V_{T}. For the practical design case of I_{AC(pk)}=100 A, fₗᵢₙₑ=50 Hz, V_{T}=2.5 V, V_{DC}=5 V a value of L_{D}≈10 μH can be obtained from Equation 1 above. From this it can be seen that V_{DC} is preferably a small multiple of V_{T} such that L_{D} is large enough to dominate the effects of parasitic components and/or variations within the circuit.

As those skilled in the art will appreciate, the switching frequency of the H-bridge in the ideal case is given by

$${f}_{s} = \frac{{G}_{P}}{4 {L}_{D}} ( {V}_{DC} - \frac{{V}_{T}^{2}}{{V}_{DC}} ) \qquad ( 2 )$$

A ripple current of 2 A requires G_{P}=1 giving fₛ≈100 kHz. This frequency is within the capabilities of standard MOSFET devices operating under the conditions present within the diverter circuit. Note that the non-linear hysteresis controller possesses a very high effective bandwidth approaching that of its switching frequency and provides guaranteed tracking of the quantity I_{S} within the band

$$[ \frac{- 1}{{G}_{P}} , \frac{1}{{G}_{P}} ] .$$

### The Linear Voltage Controller

The linear voltage controller 72 is designed to regulate the switch voltage 32, 33 (V_{SL} or V_{SR}) to zero by introducing a small additional current demand to the hysteresis controller. The resulting extra current flows in the diverter capacitor 57 (C_{D}). The bandwidth of the voltage controller can be low when compared to that of the hysteresis controller. This allows the design of the voltage loop compensator to proceed with the assumption that the current control loop can be modelled as a simple gain, disregarding higher-order effects. In the practical case of a loop containing a hysteresis controller with a finite switching frequency it is necessary to limit the voltage controller outer loop bandwidth to well below that of the inner current loop. For the practical switching frequency of around 100 kHz given above, a first order low pass filter with a cut-off frequency of 1 kHz suffices.

In summary, with respect to either of the primary switches 32, 33 (S_{L} or S_{R}), the controlled source 36 allows:
1) Zero current when the switch is closed—the inner hysteresis controller 71 works directly on measured currents to keep switch current at zero.
2) Seamless transition between closed and open states—the placement of the current sensor is such that an open switch causes its output to be zero, thus the hysteresis controller 71 sees a zero current error when the switch is open. However, the outer voltage loop 72 now sees a voltage error building across the switch and generates a new current error to compensate for this.
3) Zero voltage when the switch is open—the outer linear control loop 72 produces a current demand to the hysteresis controller 71 designed to generate a voltage across capacitor C_{D} 57 that maintains the switch voltage at zero.
4) Seamless transition between open and closed states—when the switch is closed the voltage across it is zero, producing a zero input to the outer voltage loop 72, effectively disabling this loop. However, the current sensor outputs are no longer implicitly identical and so the hysteresis controller 71 must work to keep this current error small.

The system described above is capable of performing an automatic and seamless transition from the voltage source state to the current source states (and vice versa) without requiring any explicit timing information regarding switch position. The mechanical position of the switch contacts does not need to be measured and hence there is no necessity for re-calibration of complex sensing mechanisms as the switch contacts wear. Component C_{D} 57, which is effectively a voltage-defining impedance, transforms a current error (because of an open switch) to a voltage error visible by the controller (the input/output current sensing can inherently not see this). The capacitor can be small (of the order of 100 μF for 120 A load current) because the controller has a high bandwidth and acts very quickly to bring the voltage to zero (effectively it injects a negative current into the capacitor). The inclusion of the capacitor C_{D} 57 and the corresponding measurement of the voltage across the primary switch 32, 33 (S_{L} or S_{R}) in question, coupled with the realisation that a non zero voltage here corresponds to a current error that is caused by the switch being open (the capacitor 57 integrates the error current) allows an automatic and seamless transition from one state to another without requiring any timing information. If a negative current is injected (under closed loop control) to charge or discharge the capacitor 57 as appropriate, the switch voltage is zero even while it is open. When the switch is closed the capacitor 57 is effectively removed from the circuit and the current sensor provides the current error directly.

The control system requires no ‘forewarning’ or timing information, it is ‘intelligent’ in the sense that it is a self contained system that depends only on the switch movement and requires no higher level management (self managed).

The diverter may operate indefinitely with the switch open—it is not vulnerable to ‘drift’ as a system employing an estimator or PLL for predicting the load current and/or switch voltages may be.

This system is not adversely affected by a distorted mains waveform or a load current change mid-tap. Near zero switch voltage and current can be guaranteed for a broad range of mains waveforms, including load currents suffering severe harmonic distortion (or indeed for DC load currents)—this has been verified experimentally.

### Simulation of the New Tap Changing Scheme

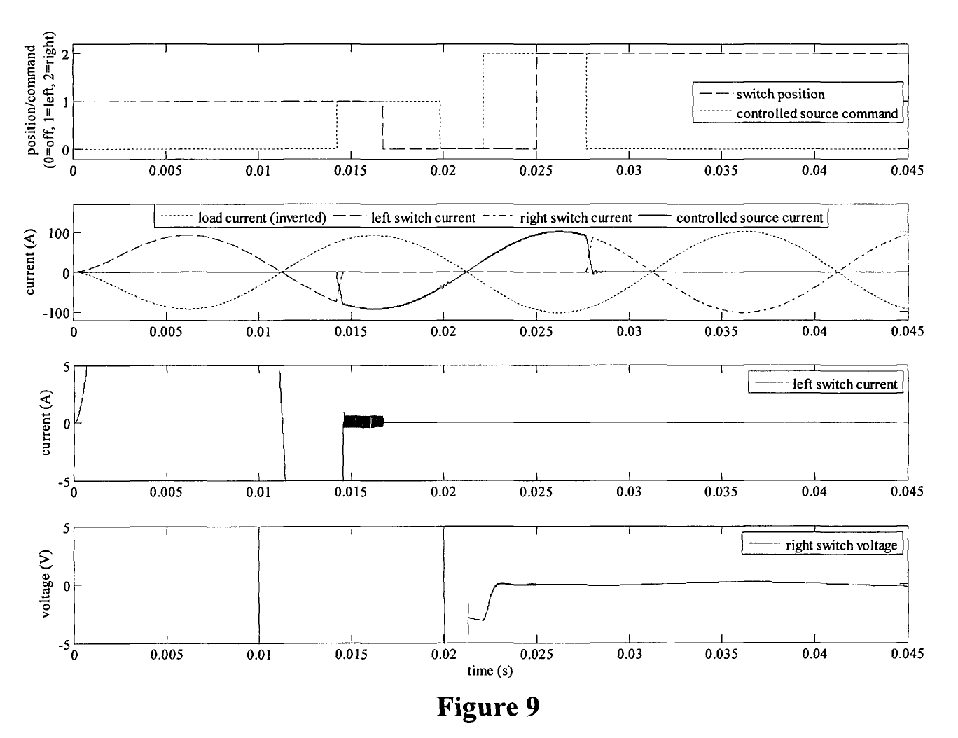

FIG. 9 shows the result of a full numerical simulation of the system incorporating a switched mode amplifier performing a single tap-up operation under various (non-ideal) conditions, e.g. with inclusion of parasitic inductances and resistances, operation with distorted supply voltages and with a time varying load current. The diverter circuit used in the simulation is that of FIG. 6 and the control loop is that of FIG. 8. The following describes the tap change process driven by the edges of the switch position and controlled source command signals shown in the top-most plot. All the values mentioned are merely examples used for the purpose of this simulation.
1. At 0.014 s—The tap change operation begins. The switch voltage input to the controller is set to the left hand switch 32 voltage and the controlled source 36 is enabled. As the left switch voltage is practically zero (as the switch is closed) the inner hysteresis controller 71 acts to drive the switch current rapidly to zero.
2. At 0.017 s—The left switch 32 opens under a condition of near-zero current (note the small ripple current generated by the hysteresis controller in the magnified plot of left switch current). The controller 70 is now operating to keep the left switch 32 voltage at zero by controlling the current flowing in capacitor C_{D} 57.
3. At 0.020 s—The controlled source 36 is switched off as it is assumed the switch 32 has opened sufficiently to sustain a voltage between its contacts.
4. At 0.021 s—The load current reaches the zero crossing point. A left-to-right current handover is performed by suitable control of the gate currents of the thyristor pairs 34, 35.
5. At 0.022 s—The switch voltage input to the controller is set to the right hand switch 33 voltage and the controlled source 36 is enabled. As the right hand switch 33 current is zero (as the switch is open), the outer control loop 72 acts to drive the switch voltage to near-zero in less than 3 ms.
6. At 0.025 s—The right hand switch 33 reaches the closed position under a condition of near-zero voltage (note the small ripple voltage just visible in the plot of right switch voltage. This is generated by the hysteresis controller 71 ripple current acting through capacitor C_{D} 57). The controller is now operating to keep the right switch 33 current at zero through action of the inner hysteresis controller 71.
7. At 0.028 s—The controlled source 36 is switched off as it is assumed the right hand switch 33 is fully closed and ready to conduct the load current. The load current diverts rapidly into the switch. The tap change is now complete.

### Mechanical Switching Aspects of the New Scheme

The minimum time required to perform a single tap change under the new scheme is fundamentally limited only by the solid state components of the tap changer; every tap change operation must cover a zero crossing of the load current in order to effect the handover from one side of the diverter circuit to the other. The maximum sequential tap-to-tap speed of the scheme is limited by the speed of the electronic diverter circuitry only as repeated tap changing can occur without requiring the diverter switches or selector switches to operate: both diverter switches 32, 33 may be opened and the load current continuously carried by the diverter thyristor pairs 34, 35 until the final tap position is reached (at which point the appropriate diverter switch is closed to resume low loss operation). To guarantee a speed of operation that is not mechanically restricted, pairs of anti-parallel thyristors may be placed in parallel with the selector switches of FIG. 3 (the selector thyristor pairs must be able to withstand the total tap voltage range, which may be up to 20% of the line voltage). In this case a rapid multi-tap operation may be carried out by opening all selector switches and allowing the load current to be carried by the thyristor pairs in turn until the final tap is reached. The selector switch corresponding to the final tap would then be closed to resume low loss operation.

Despite the fact that tap changing speed may potentially be made entirely independent of the speed of the mechanical switches, fast mechanical switches are still desirable under the new scheme for two major reasons:
1. The time required by the system between receiving a tap change command and carrying out the tap change operation is directly dependent on the time required to open the closed diverter switch. A slow diverter switch would effectively incur a latency penalty; the system must wait until the diverter switch is fully open before performing a current handover at the next load current zero crossing. The worst case latency is therefore

$$\frac{1}{2 {f}_{line}} + {t}_{s} ,$$

i.e. half the mains period plus the time required for the diverter switch to reach the guaranteed fully open state. In order to minimise the ‘first tap latency’ it is desirable to have a diverter switch capable of opening within one period of the mains waveform, i.e. in under 20 ms (for a 50 Hz mains waveform).
2. Under fault conditions a fast diverter switch will offer greater protection to the semiconductor devices used within the diverter. During a tap change operation, the load current through the diverter is carried solely by the H-bridge circuit and a thyristor pair. If a fault were to occur ‘mid-tap’ then the fault current would flow through these potentially sensitive devices. However, the fault current can be diverted rapidly away from the semiconductor device path by the closure of the appropriate diverter switch. Thus, if a fault current were detected the diverter switch would be triggered to close immediately and the semiconductor devices must only survive the fault current for the period of time required for the switch to reach the closed state. A faster diverter switch directly translates into relaxed requirements regarding the fault behaviour of the semiconductor devices.

### Further Applications

### Further Application of Zero Current, Zero Voltage Mechanical Switching

The circuit principles and control method that have been designed for use under the new tap changing scheme are equally valid for other low wear, high speed mechanical switching applications. The requirement for load current zero crossings in order to commutate-off the thyristor portion of the design may be eliminated by replacing these components with gate turn off thyristors (GTOs) or insulated gate bipolar transistors (IGBTs) that may be forced off. In this case the operating principle of the diverter circuit can be extended to DC circuits, indeed, the control problem is perhaps eased when considering a constant load current.

### Fast Tap Changer Network Deployment and High Level Control Schemes

The new scheme offers high speed tap changing with a much higher limit on the total lifetime number of operating cycles (which are limited in the case of the classic OLTC due to wear considerations). If such devices were to be incorporated into an electricity distribution network finer and faster voltage compensation may be applied when required.

### CONCLUSION

The issues of switch contact wear in a classic mechanical on-load tap changing transformer was noted and a semiconductor-assisted diverter was suggested as a solution. A method of arcless diversion for on-load tap changing transformers that involves inserting no extra electronic components in the load current path has been presented and compared to existing semiconductor assisted OLTC designs in the literature. The concept of using a controlled voltage source to null current in a mechanical switch represents a new method of performing on-load current diversion in tap changing transformers.

A circuit implementation and a corresponding control scheme were introduced as key parts of the new design and the performance of the system has been analysed in numerical simulation, the results of which have shown sound theoretical performance. The system has also been verified experimentally under conditions appropriate for an 11 kV 2 MVA distribution transformer.

### Summary of the Benefits of the Proposed New OLTC Design

Various ‘semiconductor assisted’ OLTC systems have been presented by industry and academia which offer faster operation and enhanced lifetime over the classic OLTC. However these systems incur their own penalties in terms of operating losses and tolerance to fault currents.

The new scheme offers a key advantage over previous designs: It has no semiconductors in the steady-state load current path. Therefore it incurs no extra power losses during steady-state operation and maintains the robustness of a purely mechanical system against fault currents.

The new scheme is likely to be comparable (if not superior) to other semiconductor-assisted systems in terms of manufacturing costs. It requires no special or unusual components and is efficient in its use of semiconductor devices.

Potentially the scheme will scale well. The circuit topology may be expected to scale to extra high voltage (or transmission level) OLTC transformers. The circuit implementation details (semiconductor device types and mechanical switch design) may change but the fundamental principle of operation will remain unchanged, that is, the application of a controllable source in the diversionary current path to cause current diversion, and the use of zero-voltage, zero-current mechanical switching.

### REFERENCES

[1] R. Shuttleworth, X. Tian, C. Fan, and A. Power, “New tap changing scheme,” Electric Power Applications, IEE Proceedings, vol. 143, no. 1, pp. 108-112, January 1996.
[2] G. Cooke and K. Williams, “New thyristor assisted diverter switch for on load transformer tap changers,” Electric Power Applications, IEE Proceedings B [see also IEE Proceedings—Electric Power Applications], vol. 139, no. 6, pp. 507-511, November 1992.
[3] H. Jiang, R. Shuttleworth, B. A. Zahawi, X. Tian, and A. Power, “Fast response to assisted novel tap changer,” Power Delivery, IEEE Transactions on, vol. 16, no. 1, pp. 111-115, January 2001.
[4] D. Oates and M. Saravolac, “A hybrid on-load tap changer and method of operating the same,” PCT Patent Application Publication No. WO 2007/101849 A1, September 2007.

1-52. (canceled)

53. An electrical device for use in an electricity distribution or transmission network, the device comprising:
a first current path having a primary switch therein, and means for coupling to a distribution- or transmission-level electrical supply; and
a diversionary current path having semiconductor switching means therein, the semiconductor switching means being operable to bypass the primary switch;
the device being arranged such that, in use, a first current flowing from the supply along the first current path can be diverted, on the operation of the semiconductor switching means, along the diversionary current path, bypassing the primary switch;
wherein the diversionary current path comprises a controllable electrical supply operable to supply a second current whilst the semiconductor switching means are in a state of conduction, the second current being such as to cause substantially zero current to flow through the primary switch, such that the primary switch can then be opened under a condition of substantially zero load current;
characterised in that the controllable electrical supply comprises:
an electrical source;
an amplifier having two output terminals and comprising a plurality of semiconductor devices; and
control logic arranged to operate the amplifier such that it can selectively present either current or voltage source behaviour at the terminals.

54. An electrical device as claimed in claim 53, wherein the primary switch is a first primary switch and the semiconductor switching means is a first semiconductor switching means, and the electrical device further comprises a second current path having a second primary switch therein, the second current path being switchable into electrical connection with the said means for coupling to an electrical supply; and
wherein the diversionary current path has second semiconductor switching means therein connected to the second current path and operable to bypass the second primary switch;
the device being arranged such that, in use, the first current flowing from the supply along the diversionary current path on the operation of the first semiconductor switching means therein can be further diverted, on the operation of the second semiconductor switching means, bypassing the second primary switch.

55. An electrical device as claimed in claim 54, wherein the controllable electrical supply is further operable to impose a voltage whilst the second semiconductor switching means are in a state of conduction, the voltage being such as to cause substantially zero voltage across the second primary switch when the second primary switch is open, such that the second primary switch can then be closed under a condition of substantially zero voltage;
and preferably wherein the device is further arranged such that, in use, the first current flowing from the supply along the second current path can be diverted, on the operation of the second semiconductor switching means, along the diversionary current path, bypassing the second primary switch, and the controllable electrical supply is further operable to supply a third current whilst the second semiconductor switching means are in a state of conduction, the third current being such as to cause substantially zero current to flow through the second primary switch, such that the second primary switch can then be opened under a condition of substantially zero load current;
and more preferably wherein the device is further arranged such that, in use, the first current flowing from the supply along the diversionary current path on the operation of the second semiconductor switching means can be further diverted, on the operation of the first semiconductor switching means, bypassing the first primary switch, and the controllable electrical supply is further operable to impose a voltage whilst the first semiconductor switching means are in conduction, the voltage being such as to cause substantially zero voltage across the first primary switch when the first primary switch is open, such that the first primary switch can then be closed under a condition of substantially zero voltage.

56. An electrical device as claimed in claim 53, wherein the or each semiconductor switching means comprise one or more thyristors;
preferably wherein the or each semiconductor switching means comprises a thyristor pair comprising a first thyristor and a second thyristor arranged in parallel, such that the first thyristor provides a forward current path in one direction and the second thyristor provides a forward current path in the opposite direction;
and preferably wherein the electrical source is operable to provide a voltage greater than the forward voltage drop of one of the said thyristors;
and preferably wherein the device further comprises a snubber across the or each thyristor pair.

57. An electrical device as claimed in claim 53, wherein the or each primary switch comprises a mechanical switch.

58. An electrical device as claimed in claim 54, being an on-load tap changing transformer, wherein the first and second primary switches are diverter switches of the transformer, and wherein the first and second current paths further include one or more tap selector switches.

59. An electrical device as claimed in claim 53, wherein the amplifier is a switched mode amplifier;
preferably wherein the amplifier comprises an H-bridge configuration;
and more preferably wherein the amplifier and control logic are arranged to provide hysteresis current control; and/or wherein the amplifier and control logic are arranged to provide linear voltage control.

60. An electrical device as claimed in claim 53, further comprising:
an inductor in series with a terminal of the amplifier; and
a diverter path across the inductor and an output of the amplifier, the diverter path comprising a voltage-defining impedance.

61. An electrical device as claimed in claim 60, wherein the voltage-defining impedance comprises a capacitor and/or a resistor.

62. An electrical device as claimed in claim 60, wherein the control logic comprises a current control loop arranged to:
derive a current error signal directly from the current flowing in the first or second primary switches or indirectly from the load current and the current through the terminals of the amplifier; and
provide a voltage output across the output terminals of the amplifier so as to alter the current through the terminals of the amplifier;
such that the current error signal is substantially zero.

63. An electrical device as claimed in claim 60, wherein the control logic comprises a voltage control loop arranged to:
obtain the voltage across a primary switch;
derive a voltage control output signal from the voltage across the said primary switch, thereby providing an additional current demand on the current control loop; and
inject current into the voltage-defining impedance so as to render the voltage across the said primary switch substantially zero.

64. An electrical device as claimed in claim 63, wherein the control logic further comprises a voltage control loop compensator;
and preferably wherein the voltage control loop compensator comprises a first order low pass filter with a cut-off frequency of approximately 20 times the line frequency.

65. A method of operating a mechanical switch in an electrical device within an electricity distribution or transmission network, the method comprising:
providing a first current path having a primary switch therein, coupled to a distribution- or transmission-level electrical supply such that a first electrical current flows through the primary switch;
providing a diversionary current path having semiconductor switching means and a controllable electrical supply therein, the diversionary current path being operable to bypass the primary switch;
bringing the semiconductor switching means into a state of conduction;
supplying a second current from the controllable electrical supply whilst the semiconductor switching means are in the state of conduction such that substantially zero current flows through the primary switch; and then
opening the primary switch under a condition of substantially zero load current;
the method characterised in that the controllable electrical supply comprises an electrical source, an amplifier having two output terminals and comprising a plurality of semiconductor devices, and control logic;
and the method further comprises the control logic operating the amplifier such that it selectively presents either current or voltage source behaviour at the terminals.

66. A method as claimed in claim 65, wherein the primary switch is a first primary switch and the semiconductor switching means is a first semiconductor switching means, and the method further comprises:
providing a second current path having a second primary switch therein, the second current path being switchable into electrical connection with the electrical supply;
providing second semiconductor switching means in the diversionary current path and connected to the second current path, the second semiconductor switching means being operable to bypass the second primary switch;
bringing the second semiconductor switching means into a state of conduction;
imposing a voltage from the controllable electrical supply whilst the second semiconductor switching means are in the state of conduction, the voltage being such as to cause substantially zero voltage across the second primary switch when the second primary switch is open;
closing the second primary switch under a condition of substantially zero voltage; and then
disabling the controllable electrical supply and thereby causing the first electrical current to flow through the second primary switch.

67. A method as claimed in claim 66, further comprising:
bringing the second semiconductor switching means into a state of conduction;
supplying a third current from the controllable electrical supply whilst the second semiconductor switching means are in the state of conduction, such that substantially no current flows through the second primary switch; and then
opening the second primary switch under a condition of substantially zero load current.

68. A method as claimed in claim 67, further comprising:
bringing the first semiconductor switching means into a state of conduction;
imposing a voltage from the controllable electrical supply whilst the first semiconductor switching means are in the state of conduction, the voltage being such as to cause substantially zero voltage across the first primary switch when the first primary switch is open;
closing the first primary switch under a condition of substantially zero voltage; and then
disabling the controllable electrical supply and thereby causing the first electrical current to flow through the first primary switch.

69. A method as claimed in claim 66, wherein each semiconductor switching means comprises a thyristor pair comprising a first thyristor and a second thyristor arranged in parallel, such that the first thyristor provides a forward current path in one direction and the second thyristor provides a forward current path in the opposite direction; the method further comprising, whilst the first electrical current is positive:
bringing a first thyristor in the first semiconductor switching means into a state of conduction in a forward direction; and
when the first electrical current makes its next zero crossing, observing/measuring the voltage across the first thyristor in the first semiconductor switching means in order to ensure that it has become fully blocking before bringing a first thyristor in the second semiconductor switching means into conduction in a forward direction.

70. A method as claimed in claim 66, wherein each semiconductor switching means comprises a thyristor pair comprising a first thyristor and a second thyristor arranged in parallel, such that the first thyristor provides a forward current path in one direction and the second thyristor provides a forward current path in the opposite direction; the method further comprising:
bringing a first thyristor in the first semiconductor switching means into a state of conduction in a forward direction; and then
bringing a first thyristor in the second semiconductor switching means into a state of conduction in a forward direction such that the first thyristor in the first semiconductor switching means becomes reverse biased and enters the blocking state; and then
applying a triggering signal to the second thyristor in the second semiconductor switching means such that it provides a forward conduction path when the first electrical current makes its next zero crossing.

71. A method as claimed in claim 66, wherein each semiconductor switching means comprises a thyristor pair comprising a first thyristor and a second thyristor arranged in parallel, such that the first thyristor provides a forward current path in one direction and the second thyristor provides a forward current path in the opposite direction; the method further comprising:
bringing a first thyristor in the first semiconductor switching means into a state of conduction in a forward direction; and then
applying a triggering signal to a first thyristor in the second semiconductor switching means such that it provides a forward conduction path when the first electrical current makes its next zero crossing.
